(19) United States
(12) Patent Application Publication
(10) Pub. No.: US 2004/0216583 A1
(43) Pub. Date: Nov. 4, 2004

(54) Apparatus and methods for enhancing the sound of a musical instrument

(76) Inventor: Joseph E. Calzone III, Easton, CT (US)

Correspondence Address: LAW OFFICE OF BARRY R LIPSITZ, 755 MAIN STREET, MONROE, CT, 06468, US

(21) Appl. No.: 10/824,986

(22) Filed: Apr. 14, 2004

Related U.S. Application Data
(60) Provisional application No. 60/466,666, filed on Apr. 30, 2003.

(51) Int. Cl. G10G 1/00; G10H 3/06

(52) U.S. Cl. 84/453

(57) ABSTRACT

The present invention provides apparatus and methods for enhancing the sound of musical instruments using an acoustically reflective element. In an example embodiment of the present invention, an acoustically reflective element is provided. This acoustically reflective element is adapted to be placed on the floor underneath a musical instrument such that sound waves from the musical instrument which strike the reflective element are reflected upward, thereby enhancing the sound of the musical instrument. A protective band may be provided around a perimeter of the reflective element. This protective band will prevent the edge of the reflective element from cutting the user or causing other damage.

This application claims the benefit of U.S. provisional patent application No. 60/466,666 filed on Apr. 30, 2003, which is incorporated herein and made a part hereof by reference.

### BACKGROUND OF THE INVENTION

The present invention relates generally to musical instruments, and more particularly to apparatus and methods for enhancing the sound of musical instruments using an acoustically reflective element.

Often, musicians set up their instruments on a sound absorbing surface, such as a carpeted floor. This sound absorbing surface can deaden the sound of the instrument by absorption.

It would be advantageous to provide methods and apparatus for enhancing the sound of instruments when played above carpet or other sound absorbing surface. It would be further advantageous if such methods and apparatus were simple and inexpensive.

The present invention, which provides an acoustically reflective disk for the enhancement of sound from musical instruments, enjoys the aforementioned and other advantages.

### SUMMARY OF THE INVENTION

The present invention provides apparatus and methods for enhancing the sound of musical instruments using an acoustically reflective element. In an example embodiment of the present invention, an acoustically reflective element is provided. This acoustically reflective element is adapted to be placed on the floor underneath a musical instrument such that sound waves from the musical instrument which strike the reflective element are reflected upward, thereby enhancing the sound of the musical instrument.

The reflective element may be a disk shaped element. The reflective element may be a flat piece of material that is ⅛ of an inch thick or less. Further, the reflective element may be shaped as a circle, a square, a rectangle, an oval, a hexagon, an octagon, a half-circle, or any other suitable shape.

The reflective element may enhance the crispness of the sound and/or the brightness of the sound. Further, the reflective element may increase the apparent volume of the sound.

The reflective element may be made of any acoustically reflective material, such as stainless steel, aluminum, copper, brass, wood, hard plastic, or similar material.

The musical instrument may comprise a percussion instrument. For example, the musical instrument may comprise a drum. In addition, the reflective element may be used with other musical instruments, such as a xylophone, a chime, a cymbal, a gong, a triangle, tambourine, or the like.

In a further example embodiment of the present invention, a protective band may be provided around a perimeter of the reflective element. This protective band will prevent the edge of the reflective element from cutting the user or causing other damage. The protective band may comprise soft plastic, rubber, cloth, wood, or any other suitable material, which may be placed around the perimeter of the reflective element using a press fit or other suitable method of attachment. Alternatively, the reflective element may have a rounded edge to prevent injury or damage.

### BRIEF DESCRIPTION OF THE DRAWINGS

The present invention will hereinafter be described in conjunction with the appended drawing figures, wherein like reference numerals denote like elements, and:

FIG. 1 shows a top view of an acoustically reflective element in accordance with an example embodiment of the present invention;

FIG. 2 shows a side view an acoustically reflective element in accordance with an example embodiment of the present invention; and

FIG. 3 shows an acoustically reflective element set up to reflect the sound from a drum in accordance with an example embodiment of the present invention.

### DETAILED DESCRIPTION OF THE INVENTION

The ensuing detailed description provides exemplary embodiments only, and is not intended to limit the scope, applicability, or configuration of the invention. Rather, the ensuing detailed description of the exemplary embodiments will provide those skilled in the art with an enabling description for implementing an embodiment of the invention. It should be understood that various changes may be made in the function and arrangement of elements without departing from the spirit and scope of the invention as set forth in the appended claims.

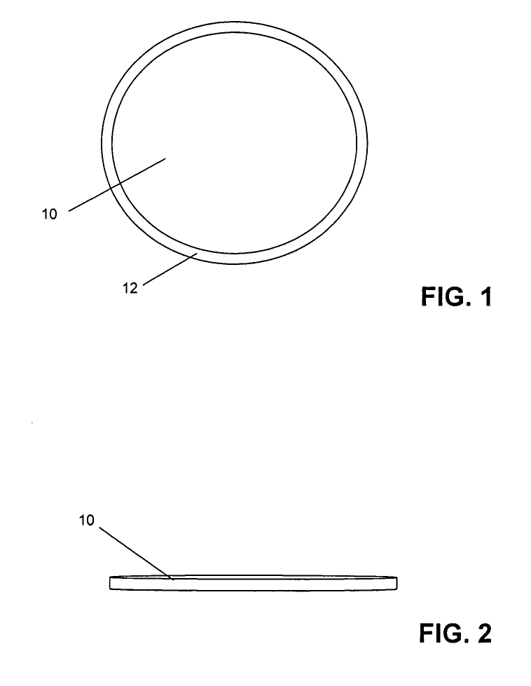

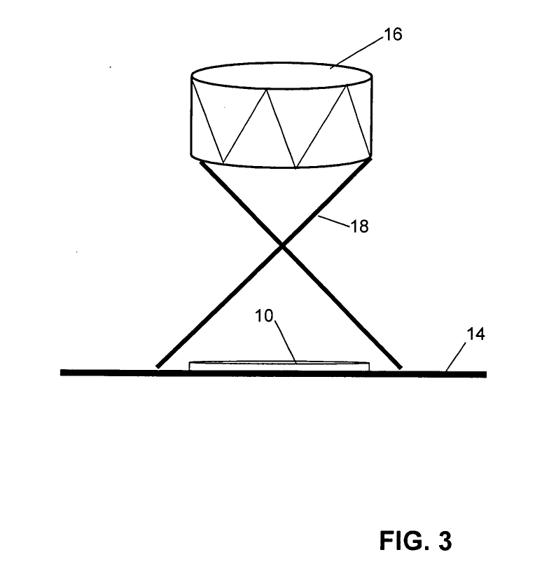

The present invention provides apparatus and methods for enhancing the sound of musical instruments using an acoustically reflective element. In an example embodiment of the present invention as shown in FIGS. 1 and 2, an acoustically reflective element 10 is provided. FIG. 1 shows a top view of the reflective element 10 and FIG. 2 shows a side view of the reflective element 10. This acoustically reflective element 10 is adapted to be placed on the floor underneath a musical instrument such that sound waves from the musical instrument which strike the reflective element 10 are reflected upward, thereby enhancing the sound of the musical instrument.

For example, as shown in FIG. 4, the reflective element 10 may be placed on the floor 14 under a musical instrument, such as a drum 16. The drum 16 is supported above the floor by legs 18. When a drummer's drumsticks hit the drum 14, the sound is projected downward towards the floor 14 and strikes the reflective element 10, which reflects the sound upwards. As many musicians set up their drums 16 (or other instruments) on a carpeted floor to prevent the drums 16 from creeping while they are being played, the reflective element 10 prevents the carpet (or other flooring material) from absorbing the sound and softening the brightness and crack of the drum 16.

The reflective element 10 may enhance the crispness of the sound and/or the brightness of the sound. Further, the reflective element 10 may increase the apparent volume of the sound.

The reflective element 10 may be a disk shaped element as shown in the Figures. The reflective element 10 may be a thin piece of flat material that is, for example, ⅛ of an inch thick or less. Further, those skilled in the art will appreciate that the reflective element 10 may be shaped as a circle, a square, a rectangle, an oval, a hexagon, an octagon, a half-circle, or any other suitable shape.

The reflective element 10 may be made of any acoustically reflective material, such as stainless steel, aluminum, copper, brass, wood, hard plastic, or similar material.

The musical instrument may comprise a percussion instrument. For example, the musical instrument may comprise a drum 16 as shown in FIG. 4. In addition, the reflective element 10 may be used with other musical instruments, such as a xylophone, a chime, a cymbal, a gong, a triangle, tambourine, or other similar instrument.

In a further example embodiment of the present invention, a protective band 12 may be provided around a perimeter of the reflective element 10, as shown in FIG. 1. This protective band 12 will prevent the edge of the reflective element 10 from cutting the user or causing other damage. The protective band 12 may comprise soft plastic, rubber, cloth, wood, or any other suitable material, which may be placed around the perimeter of the reflective element 10 using a press fit or other suitable method of attachment. Alternatively, the reflective element 10 may have a rounded edge to prevent injury or damage.

It should now be appreciated that the present invention provides advantageous methods and apparatus for enhancing the sound of a musical instrument using an acoustically reflective element.

Although the invention has been described in connection with various illustrated embodiments, numerous modifications and adaptations may be made thereto without departing from the spirit and scope of the invention as set forth in the claims.

What is claimed is:

1. An apparatus for enhancing the sound of a musical instrument, comprising:
an acoustically reflective element adapted to be placed on the floor underneath a musical instrument such that sound waves from the musical instrument which strike the reflective element are reflected upward, thereby enhancing the sound of the musical instrument.

2. An apparatus in accordance with claim 1, wherein said reflective element is a disk shaped element.

3. An apparatus in accordance with claim 1, wherein said reflective element is shaped as one of a circle, a square, a rectangle, an oval, a hexagon, an octagon, or a half-circle.

4. An apparatus in accordance with claim 1, wherein said reflective element enhances at least one of the crispness and the brightness of the sound.

5. An apparatus in accordance with claim 1, wherein said reflective element increases the apparent volume of the sound.

6. An apparatus in accordance with claim 1, wherein said reflective element is comprised of one of stainless steel, aluminum, copper, brass, wood, or hard plastic.

7. An apparatus in accordance with claim 1, wherein the musical instrument comprises a percussion instrument.

8. An apparatus in accordance with claim 1, wherein the musical instrument comprises a drum.

9. An apparatus in accordance with claim 1, wherein the instrument comprises one of a xylophone, a chime, a cymbal, a gong, a triangle, or tambourine.

10. An apparatus in accordance with claim 1, further comprising:
a protective band around a perimeter of said reflective element.

11. An apparatus in accordance with claim 10, wherein said protective band comprises one of soft plastic, rubber, cloth, or wood.

12. An apparatus in accordance with claim 1, wherein said reflective element has a rounded edge.

13. An apparatus in accordance with claim 1, wherein said reflective element is ⅛ of an inch thick or less.

14. A method for enhancing the sound of a musical instrument, comprising:
placing an acoustically reflective element on the floor underneath a musical instrument such that sound waves from the musical instrument which strike the reflective element are reflected upward, thereby enhancing the sound of the musical instrument.

15. A method in accordance with claim 14, wherein said reflective element is a disk shaped element.

16. A method in accordance with claim 14, wherein said reflective element is shaped as one of a circle, a square, a rectangle, an oval, a hexagon, an octagon, or a half-circle.

17. A method in accordance with claim 14, wherein said reflective element enhances at least one of the crispness and the brightness of the sound.

18. A method in accordance with claim 14, wherein said reflective element increases the apparent volume of the sound.

19. A method in accordance with claim 14, wherein said reflective element is comprised of one of stainless steel, aluminum, copper, brass, wood, or hard plastic.

20. A method in accordance with claim 14, wherein the musical instrument comprises a percussion instrument.

21. A method in accordance with claim 14, wherein the musical instrument comprises a drum.

22. A method in accordance with claim 14, wherein the instrument comprises one of a xylophone, a chime, a cymbal, a gong, a triangle, or tambourine.

23. A method in accordance with claim 14, further comprising:
providing a protective band around a perimeter of said reflective element.

24. A method in accordance with claim 23, wherein said protective band comprises one of soft plastic, rubber, cloth, or wood.

25. A method in accordance with claim 14, wherein said reflective element has a rounded edge.

26. A method in accordance with claim 14, wherein said reflective element is ⅛ of an inch thick or less.
